(19) United States
(12) Patent Application Publication
(10) Pub. No.: US 2017/0182662 A1
(43) Pub. Date: Jun. 29, 2017

(54) ROBOT SAFETY GUARD SYSTEM

(71) Applicant: HIWIN TECHNOLOGIES CORP., TAICHUNG CITY (TW)

(72) Inventors: Jiun-Kai HUANG, TAICHUNG CITY (TW); Po-Chiao HUANG, TAICHUNG CITY (TW); Chih-Hsuan CHEN, TAICHUNG CITY (TW); Tsung-Hsien CHIANG, TAICHUNG CITY (TW)

(21) Appl. No.: 15/367,704

(22) Filed: Dec. 2, 2016

(30) Foreign Application Priority Data
Dec. 29, 2015 (TW) 104144209

(51) Int. Cl. B25J 9/16; B25J 19/06

(52) U.S. Cl. CPC B25J 9/1674; B25J 19/06

(57) ABSTRACT

A robot safety guard system for installation in the ground around a robot with an operating range is disclosed to include a plurality of sensor modules mounted on the ground beyond the operating range of the robot. Each sensor module includes 2 first sensors each providing a first sensing range. The first sensing ranges of the first sensors of the sensor modules are combined to define a first warning area. One of the sensor modules further includes a second sensor that provides a second sensing range. The second sensing range defines a second warning area beyond the first warning area. In this way, the robot safety guard system is constructed having low construction costs, fast reaction time and space-saving.

### BACKGROUND OF THE INVENTION

1. Field of the Invention

The present invention relates to safety guard technology and more particularly, to a robot safety guard system, which he utilizes the sensing ranges of various sensors to define different warning areas so that when a foreign object intrudes into any warning area, one respective sensor is induced to transmit a signal, controlling the robot to make a corresponding action.

2. Description of the Related Art

The existing robot safety guard related designs, such as JP2007118141, commonly adopt the measure of establishing a fence around the robot for prohibiting an operator from approaching a predetermined area around the robot. Further, JP2010208002 discloses a technique that employs photography technology to detect the position of the robot. Further, JP 2015100873 teaches a color mark sensing technique for determining an operator approaching a predetermined area around the robot. Further, JP 563216692 discloses the use of image recognition technology with a pressure sensor to determine an operator approaching a predetermined area around the robot.

The fence-based robot safety guard design needs a large fence installation space, limiting its application. The robot safety guard design that employs photography technology to detect the position of the robot is not very economical because the price of the required equipment is not low. Further, the effectiveness of an image recognition based robot safety guard design depends on the accuracy of the recognition technology and the reaction speed.

### SUMMARY OF THE INVENTION

The present invention has been accomplished under the circumstances in view. It is the main object of the present invention to provide a robot safety guard system, which utilizes the sensing ranges of various sensors to define different warning areas so that when a foreign object intrudes into any warning area, one respective sensor is induced to transmit a signal, controlling the robot to make an action.

To achieve this and other objects of the present invention, a robot safety guard system is designed for installation in the ground around a robot that defines an operating range. The robot safety guard system comprises a plurality of sensor modules mounted on the ground beyond the operating range of the robot. Each sensor module comprises 2 first sensors. Each first sensor provides a first sensing range. The first sensing ranges of the first sensors of the sensor modules are combined to define a first warning area. One of the sensor modules further comprises a second sensor that provides a second sensing range. The second sensing range defines a second warning area beyond the first warning area.

Preferably, the robot safety guard system further comprises a barrier mounted on the ground and spaced from each sensor module at a distance over 50 centimeters. Further, the first sensing range of each first sensor defines with the ground a contained angle between 3 degrees and 90 degrees.

Preferably, each first sensor and the second sensor are respectively spaced above the ground at a distance between 1 centimeter and 10 centimeters.

Preferably, the sensor module carrying the second sensor further comprises a pressure sensor. The first sensors and second sensor of the sensor module carrying the pressure sensor are around in a circle around the pressure sensor.

Preferably, the first sensors and the second sensor are selected from the group of infrared sensors, ultrasonic sensors and laser sensors.

In another embodiment of the present invention, a robot safety guard system is designed for installation in the ground around a robot near a barrier. The robot defines an operating range. The barrier being is disposed at one side relative to the robot. The robot safety guard system comprises a plurality of sensor modules mounted on the ground beyond the operating range of the robot. Each sensor module comprises 2 first sensors. Each first sensor provides a first sensing range. The first sensing ranges of the first sensors of the sensor modules define with the barrier a first warning area. One of the sensor modules further comprises a second sensor. The second sensor provides a second sensing range. The second sensing range defines a second warning area beyond the first warning area.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing of a robot safety guard system in accordance with a first embodiment of the present invention, illustrating 2 sensor modules arranged around a robot.

FIG. 2 is a schematic drawing illustrating the configuration of one sensor module of the robot safety guard system in accordance with the first embodiment of the present invention.

FIG. 3 is a schematic side view of the first embodiment of the present invention, illustrating the relationship between each first sensor and the ground and the relationship between the sensor module and the barrier.

FIG. 4 is a schematic drawing of an alternate form of the first embodiment of the present invention, illustrating 4 sensor modules arranged around the robot.

FIG. 5 is a schematic drawing of another alternate form of the first embodiment of the present invention, illustrating 3 sensor modules arranged around the robot.

FIG. 6 is a schematic drawing of still another alternate form of the first embodiment of the present invention, illustrating 8 sensor modules arranged around the robot.

FIG. 7 is a schematic drawing of a robot safety guard system in accordance with a second embodiment of the present invention, illustrating 2 sensor modules arranged around a robot at one side relative to a barrier.

### DETAILED DESCRIPTION OF THE INVENTION

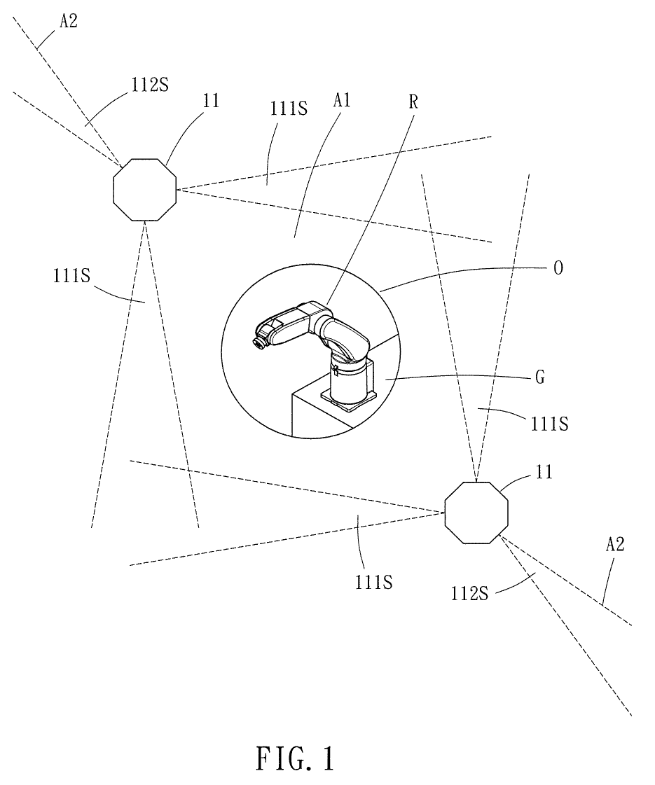

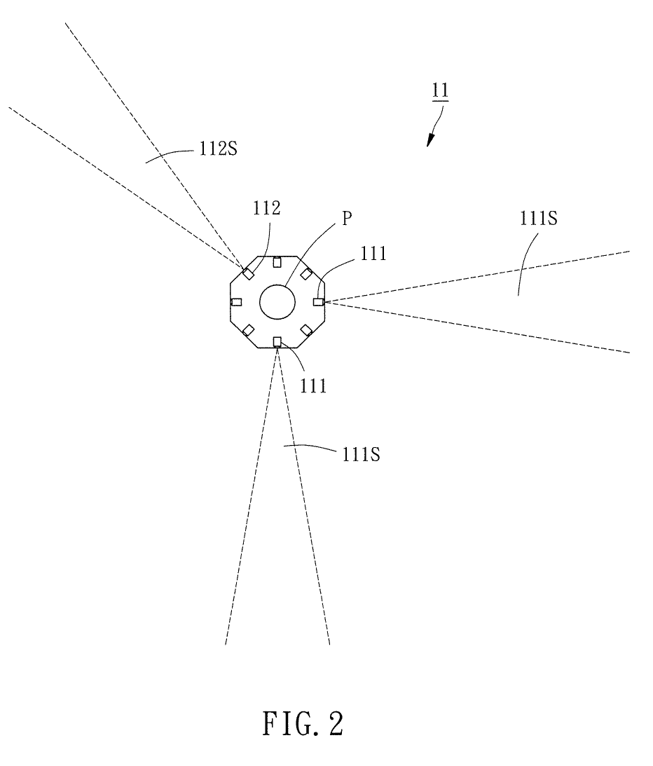

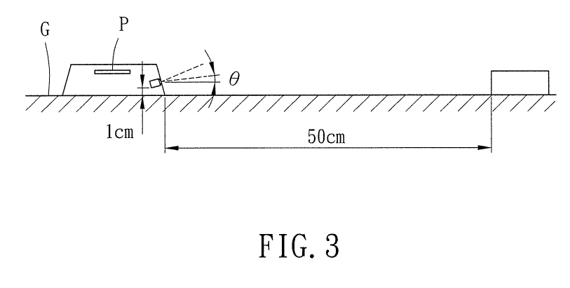

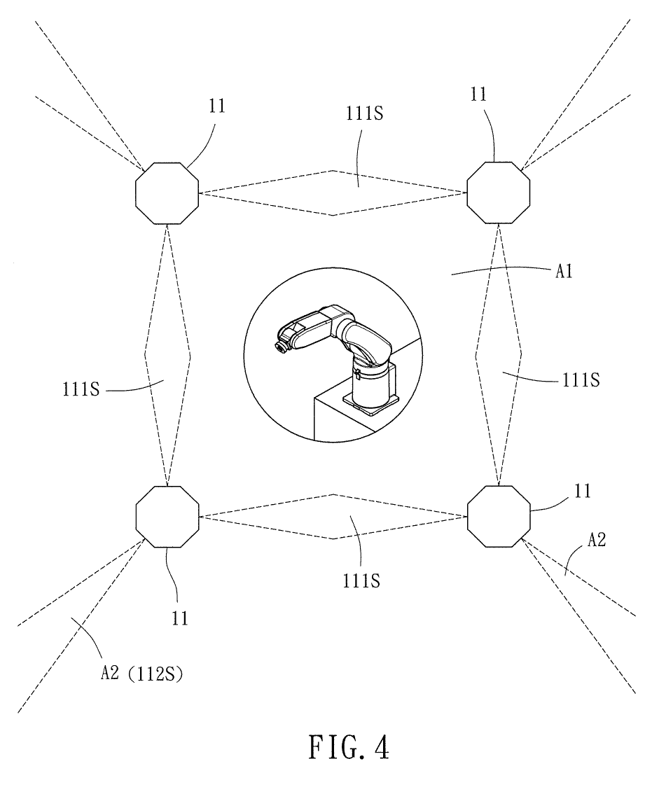

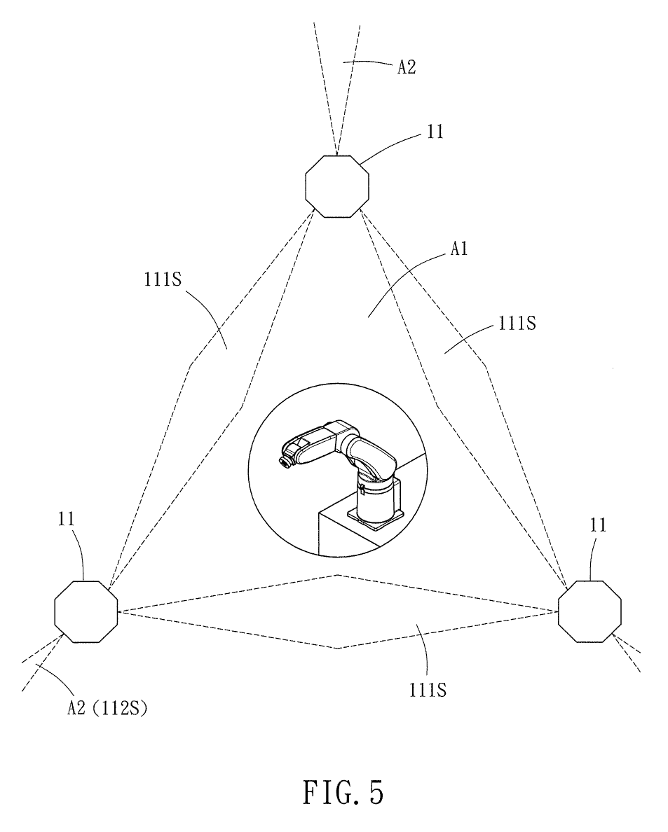

Referring to FIGS. 1-5, a robot safety guard system is used with a robot R and arranged on the ground G. The robot R has an operating range O. The robot safety guard system comprises a plurality of sensor modules 11.

Every sensor module 11 is respectively arranged on the ground G. In a first embodiment of the present, each sensor module 11 comprises two freely arranged first sensors 111. Each first sensor 111 provides a first sensing range 1115. Each sensor module 11 further comprises a second sensor 112. It is to be noted that, in this first embodiment, each sensor module 11 comprises a second sensor 112; however, the robot safety guard system can be alternatively configured to have only one second sensor 112 built in one of the sensor modules 11, achieving the same effects. Further, each second sensor 112 provides a second sensing range 112S. In this first embodiment, each sensor module totally has three sensors set therein; however, each sensor module of the robot safety guard system can also be alternatively configured to have totally four, five, six, eight or more sensors set therein.

The sensor modules 11 are arranged outside the operating range O of the robot R. Further, the first sensing ranges 111S of the first sensors 111 are combined to define a first warning area A1.

The second sensing range 112S of each second sensors 112 defines a respective second warning area A2. The second warning areas A2 are disposed outside the first warning area A1.

When a foreign intruder intrudes into one of the second warning areas A2, the respective second sensor 112 will be induced to transmit a first signal to the robot R, controlling the robot R to make an action, for example, controlling the robot R to reduce speed. Further, when a foreign intruder intrudes into the first warning area A1, one of the first sensors 111 will be induced to transmit a second signal to the robot R, controlling the robot R to make an action, for example, controlling the robot R to stop the operation.

It's worth mentioning that every first sensing range 111S defines with the ground G a contained angle θ, which is greater than 3 degrees. The purpose of this design is to prevent the first sensors 111 from sensing objects that are placed on the ground G and do not need to be detected, such as electrical lines. Further, if a barrier is placed on the ground G, and the barrier is spaced from every sensor module 11 more than 50 centimeters, the design of the said contained angle θ can also reduce the chance of sensing the barrier.

Further, the first sensors 111 and the second sensors 12 are respectively spaced above the ground G over 1 centimeter, preventing miscellaneous objects from interfering with the sensing operation of the first and second sensors 111; 12.

The robot safety guard system in accordance with the first embodiment of the present invention further comprises a pressure sensor P mounted in one of the sensor modules 11. Alternatively, the robot safety guard system can also be configured to have one respective pressure sensor P mounted in every sensor module 11. The pressure sensor P is mounted at the center of the sensor module 11 and, the first sensors 111 and second sensor 112 of the sensor module 11 are equiangularly arranged in a circle around the pressure sensor P. This arrangement enables the sensor module 11 to detect objects from different directions. When a foreign object comes from a top side and presses on the sensor module 11, the pressure sensor P can sense the intruded foreign object. Thus, the sensor modules 11 of the robot safety guard system can also effectively detect any foreign object that intrudes into first warning area A1 from the top side. In the present first embodiment, the first sensors 111 and the second sensor 112 are infrared sensors. Alternatively, ultrasonic sensors or laser sensors can be used as substitutes.

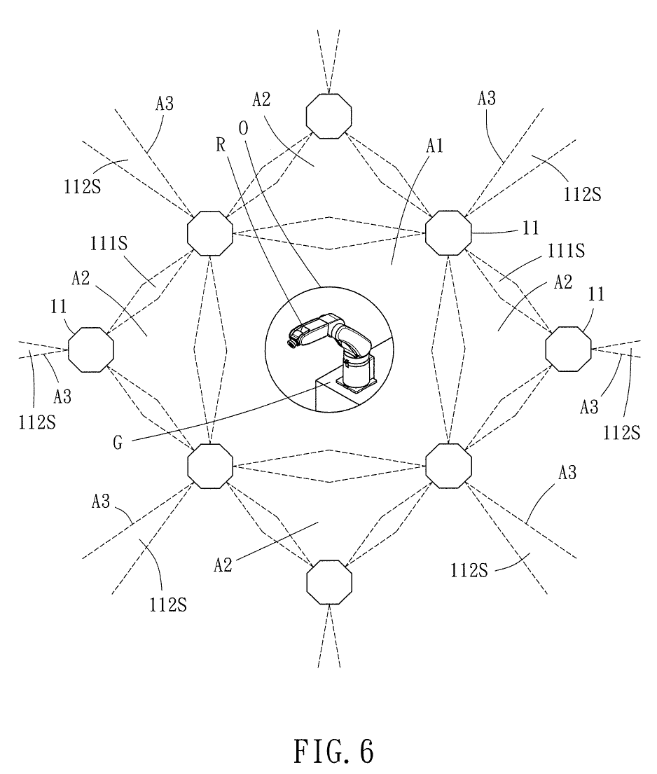

Further, in the application example shown in FIG. 6, the robot safety guard system comprises four sensor modules 11 each having 4 first sensors 111 and one second sensors 112 mounted therein, and four sensor modules 11 each having 2 first sensors 111 and one second sensors 112 mounted therein. The first sensing ranges 111S of the first sensors 111 of all sensor modules 11 are combined to define a first warning area A1 and a plurality of second warning areas A2 around the first warning area A1. The second sensing range 112S of each second sensor 112 defines a respective third warning area A3 beyond the first warning area A1 and the second warning areas A2.

When a foreign object intrudes into one of the third warning areas A3 after establishment of the first warning area A1, second warning areas A2 and third warning areas A3, the respective second sensor 112 will be induced to transmit a first signal to the robot R, controlling the robot R to make an action, for example, controlling the robot R to move at a first speed. Further, when a foreign object intrudes into one of the second warning areas A2, one of the first sensors 111 of the respective sensor module 11 will be induced to transmit a second signal to the robot R, controlling the robot R to make an action, for example, controlling the robot R to move at a second speed. This second speed is slower than the aforesaid first speed. When a foreign object intrudes into the first warning area A1, one of the first sensors 111 of one sensor module 11 will be induced to transmit a third signal to the robot R, controlling the robot R to make an action, for example, controlling the robot R to stop movement.

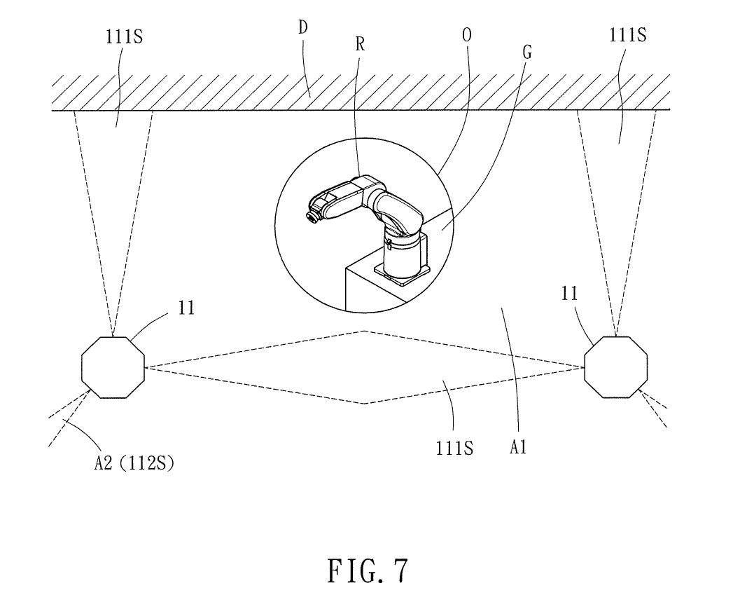

Referring to FIG. 7, robot safety guard system in accordance with a second embodiment of the present invention is shown. This second embodiment is substantially similar to the aforesaid first embodiment with the exception of the arrangement of a barrier D at one side relative to the robot R. In this second embodiment, the sensor modules 11 are arranged beyond the operating range O of the robot R; the first sensing ranges 111S of the first sensors 111 of all sensor modules 11 are combined to define a first warning area A1; the second sensing range 112S of each second sensors 112 defines a respective second warning area A2 outside the first warning area A1. The barrier D can be, for example, a wall, production line or worktable for allowing a workpiece to be placed thereon and blocking a foreign object from approaching the robot R. Thus, the barrier D and the first sensors 111 can define a warning area. When a foreign object intrudes into one of the second warning areas A2, the second sensor 112 of the respective sensor module 11 will be induced to transmit a first signal to the robot R, controlling the robot R to make an action, for example, controlling the robot R to reduce the speed. Further, when a foreign object intrudes into the first warning area A1, the first sensor 111 of one of the sensor modules 11 will be induced to transmit a second signal to the robot R, controlling the robot R to make an action, for example, controlling the robot R to stop movement.

In general, the robot safety guard system of the present invention utilizes the sensing ranges of the first sensors and second sensors thereof to define different warning areas so that when a foreign object intrudes into one of the warning areas, one respective sensor will be induced to transmit a respective signal to control the operation of the robot, achieving protection. When compared with conventional photography technology-based robot safety guard systems, the invention has the advantages of relatively lower construction costs and faster reaction time; when compared with conventional fence-based robot safety guard systems, the invention greatly saves the installation space.

1. A robot safety guard system for installation in the ground around a robot that defines an operating range, the robot safety guard system comprising a plurality of sensor modules mounted on the ground beyond said operating range of said robot, each said sensor module comprising 2 first sensors, each said first sensor providing a first sensing range, the said first sensing ranges of said first sensors of said sensor modules being combined to define a first warning area, one of said sensor modules further comprising a second sensor, said second sensor providing a second sensing range, said second sensing range defining a second warning area beyond said first warning area.

2. The robot safety guard system as claimed in claim 1, further comprising a barrier mounted on said ground and spaced from each said sensor module at a distance over 50 centimeters, wherein the said first sensing range of each said first sensor defines with the ground a contained angle between 3 degrees and 90 degrees.

3. The robot safety guard system as claimed in claim 1, wherein each said first sensor and the said second sensor are respectively spaced above the ground at a distance between 1 centimeter and 10 centimeters.

4. The robot safety guard system as claimed in claim 1, wherein one of said sensor modules further comprises a pressure sensor.

5. The robot safety guard system as claimed in claim 4, wherein the said sensor module carrying said pressure sensor has said second sensor mounted therein, and the said first sensors and said second sensor of the said sensor module carrying said pressure sensor arrange in a circle around said pressure sensor.

6. The robot safety guard system as claimed in claim 1, wherein said first sensors and said second sensor are selected from the group of infrared sensors, ultrasonic sensors and laser sensors.

7. A robot safety guard system for installation in the ground around a robot near a barrier, said robot defining an operating range, said barrier being disposed at one side relative to said robot, the robot safety guard system comprising a plurality of sensor modules mounted on the ground beyond said operating range of said robot, each said sensor module comprising 2 first sensors, each said first sensor providing a first sensing range, the said first sensing ranges of said first sensors of said sensor modules defining with said barrier a first warning area, one of said sensor modules further comprising a second sensor, said second sensor providing a second sensing range, said second sensing range defining a second warning area beyond said first warning area.

8. The robot safety guard system as claimed in claim 1, wherein when a foreign object intrudes into said second warning area, said second sensor is induced to transmit a first signal to said robot, controlling said robot to make an action; when a foreign object intrudes into said first warning area, one respective said first sensor is induced to transmit a second signal to said robot, controlling said robot to make an action; the mode of said action of said robot is to reduce the speed or to stop movement.

9. A robot safety guard system for installation in the ground around a robot that defines an operating range, the robot safety guard system comprising a plurality of sensor modules mounted on the ground beyond said operating range of said robot, each said sensor module comprising a plurality of first sensors and a second sensor, each said first sensor providing a first sensing range, each said second sensor providing a second sensing range, the said first sensing ranges of said first sensors of said sensor modules being combined to define a first warning area and a second warning area around said first warning area, the said second sensing range of the said second sensor of each said sensor module defining a third warning area beyond said first warning area and said second warning area.

10. The robot safety guard system as claimed in claim 9, wherein when a foreign object intrudes into one of said third warning areas, the respective said second sensor is induced to transmit a first signal to said robot, controlling said robot to move at a first speed; when a foreign object intrudes into said second warning area, one of said first sensors of the respective said sensor module is induced to transmit a second signal to said robot, controlling said robot to move at a second speed slower than said first speed; when a foreign object intrudes into said first warning area, one of said first sensors of one of said sensor modules is induced to transmit a third signal to said robot, controlling said robot to stop movement.

11. The robot safety guard system as claimed in claim 7, wherein when a foreign object intrudes into said second warning area, said second sensor is induced to transmit a first signal to said robot, controlling said robot to make an action; when a foreign object intrudes into said first warning area, one respective said first sensor is induced to transmit a second signal to said robot, controlling said robot to make an action; the mode of said action of said robot is to reduce the speed or to stop movement.
